(19) United States
(12) Patent Application Publication
(10) Pub. No.: US 2025/0286484 A1
(43) Pub. Date: Sep. 11, 2025

(54) SYSTEM AND METHOD FOR SPEED-TORQUE CONTROL OF BRUSHED DC MOTORS

(71) Applicant: Steering Solutions IP Holding Corporation, Saginaw, MI (US)

(72) Inventors: Md Abid Hossain, Saginaw, MI (US); Thomas J. Stutts, Linwood, MI (US)

(21) Appl. No.: 18/595,961

(22) Filed: Mar. 5, 2024

(51) Int. Cl. H02P 7/14; B62D 5/04

(52) U.S. Cl. CPC H02P 7/14; B62D 5/0409; B62D 5/046

(57) ABSTRACT

Technical solutions are described for controlling a brushed direct current (DC) motor, including: determining a speed difference signal based on a difference between a speed command signal and a motor speed of the brushed DC motor; determining a torque command signal based on the speed difference signal; determining a voltage command based on the torque command signal; and applying a DC voltage to the brushed DC motor based on the voltage command. Determining the torque command signal based on the speed difference signal further includes at least one of: determining a modified proportional torque component including a feedforward gain term times the speed command signal, with the torque command signal including the modified proportional torque component; and/or determining a modified derivative torque component including a time derivative of the motor speed of the brushed DC motor, with the torque command signal including the modified derivative torque component.

### BACKGROUND

The present disclosure relates to methods and systems for operating brushed DC motors.

Brushed DC motors are used in various applications. One such application for brushed DC motors is in power steering systems for vehicles. Significant advantages of brushed DC motors, when compared with alternatives such as AC motors, include low-cost components, less circuitry, simplicity, and ease of control.

For smooth operation and better customer experience, active speed control may be used for controlling a brushed DC motor of a column position module (CPM) with a speed-to-torque controller.

### SUMMARY

According to one or more embodiments, a method of controlling a brushed direct current (DC) motor includes: determining a speed difference signal based on a difference between a speed command signal and a motor speed of the brushed DC motor; determining a torque command signal based on the speed difference signal; determining a voltage command based on the torque command signal; and applying a DC voltage to the brushed DC motor based on the voltage command. The torque command signal includes at least one of a modified proportional torque component and/or a modified derivative torque component. Determining the torque command signal includes at least one of: determining the modified proportional torque component including a feedforward gain term times the speed command signal, and/or determining the modified derivative torque component including a time derivative of the motor speed of the brushed DC motor.

According to one or more embodiments, a motor control system is provided. The motor system includes: a brushed direct current (DC) motor having a set of brushes; a voltage regulator configured to apply a DC voltage to the brushed DC motor based on a voltage command; and a controller configured to: determine a speed difference signal based on a difference between a speed command signal and a motor speed of the brushed DC motor; determine a torque command signal based on the speed difference signal; and determine the voltage command based on the torque command signal. The torque command signal includes at least one of a modified proportional torque component and/or a modified derivative torque component. Determining the torque command signal includes at least one of: determining the modified proportional torque component including a feedforward gain term times the speed command signal, and/or determining the modified derivative torque component including a time derivative of the motor speed of the brushed DC motor.

According to one or more embodiments, a method of operating a brushed direct current (DC) motor for adjusting the column position of a steering system in a vehicle is provided. The method includes: determining a speed difference signal based on a difference between a speed command signal and a motor speed of the brushed DC motor; determining a torque command signal based on the speed difference signal; determining a voltage command based on the torque command signal; and applying a DC voltage to the brushed DC motor based on the voltage command. The torque command signal includes at least one of a modified proportional torque component, a modified derivative torque component, and/or a position-dependent torque component. Determining the torque command signal includes at least one of: determining the modified proportional torque component including a feedforward gain term times the speed command signal, determining the modified derivative torque component including a time derivative of the motor speed of the brushed DC motor, and/or determining the position-dependent torque component based on at least one of a position and a direction of the brushed DC motor.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 shows a column position module (CPM) of a steering system in a vehicle, according to aspects of the present disclosure;

FIG. 2 shows a schematic block diagram of a system for controlling a brushed DC motor, according to aspects of the present disclosure;

FIG. 3A shows a graph of relative pitch over time for a CPM module moving in a column down direction, according to aspects of the present disclosure;

FIG. 3B shows a graph showing a fast Fourier transform (FFT) analysis of pitch vs. frequency for the CPM module moving in the column down direction;

FIG. 4 shows a schematic block diagram of a motor controller for operating a DC motor, according to aspects of the present disclosure;

FIG. 5 shows a graph of motor speed vs. time, using each of a traditional control technique and a control technique of the present disclosure, each in a voltage mode, according to aspects of the present disclosure;

FIG. 6 shows a graph of motor speed vs. time, using each of a traditional control technique and a control technique of the present disclosure, each in a current control mode, according to aspects of the present disclosure; and

FIGS. 7A-7B show a flow diagram listing steps in a method for operating a DC motor, according to aspects of the present disclosure.

### DETAILED DESCRIPTION

Referring now to the figures, where the present disclosure will be described with reference to specific embodiments, without limiting the same, it is to be understood that the disclosed embodiments are merely illustrative of the present disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

As used herein the terms module and sub-module refer to one or more processing circuits such as an application specific integrated circuit (ASIC), an electronic circuit, a processor (shared, dedicated, or group) and memory that executes one or more software or firmware programs, a combinational logic circuit, and/or other suitable components that provide the described functionality. As can be appreciated, the sub-modules described below can be combined and/or further partitioned.

Generally, friction and load torques are not incorporated while designing a speed-to-torque controller for operating a brushed DC motor. However, for certain applications where the load and friction torques are high and depend significantly on a position of a driven assembly, a controller may advantageously incorporate these torques to provide desired smooth performance. Operation of a column position module (CPM) is one such application where the load and friction torques are relatively high and depend significantly on a position of the column module driven by a brushed DC motor. Thus, incorporating these load and friction torques can provide advantageous results for operating brushed DC motors in the CPM.

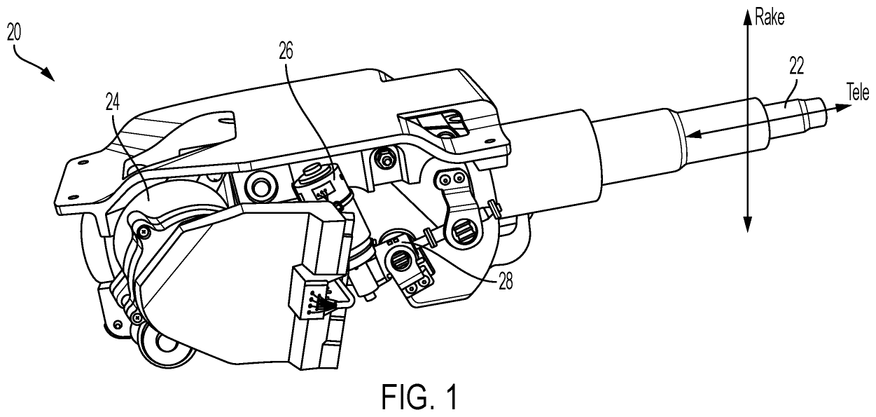

Referring now to the figures, where the technical solutions will be described with reference to specific embodiments, without limiting same, FIG. 1 shows an exemplary embodiment of a column position module (CPM) 20 of a steering system in a vehicle, and which may utilize the disclosed systems and methods for controlling a DC motor.

The CPM 20 includes a steering shaft 22 configured to attach to a steering wheel, which may also be called a hand wheel, that can be used by a person for steering a vehicle. The CPM 20 includes a steering actuator 24 attached to the steering shaft. The steering actuator 24 may supplement the person's application of force in order to provide power-assisted steering function. The CPM 20 also includes a telescoping actuator motor 26 configured to control an axial position of the handwheel by moving the steering shaft 22 in an axial direction. The CPM 20 also includes a rake actuator motor 28 configured to control a vertical position of the handwheel by moving an end the steering shaft in a radial direction.

Any or all of the steering actuator 24, the telescoping actuator motor 26 and/or the rake actuator motor 28 may include brushed DC motors and may be controlled using the systems and methods of the present disclosure. However, the systems and methods of the present disclosure may be used with brushed DC motors in other applications in a vehicle, such as for window or lock actuators. The systems and methods of the present disclosure are not limited to use in vehicles, and may be used with brushed DC motors in a variety of different applications.

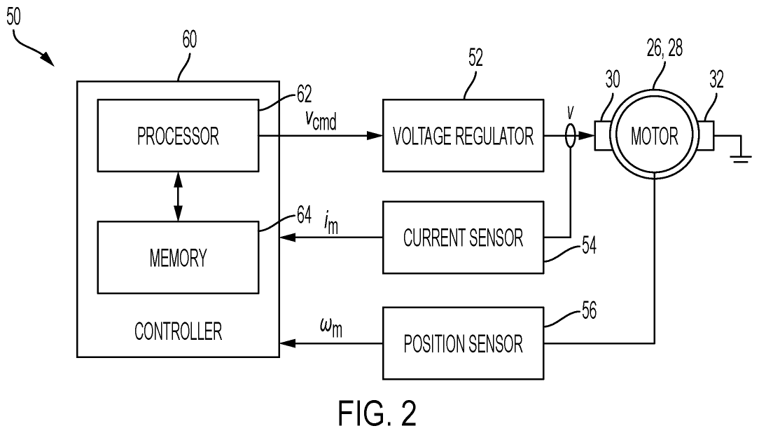

FIG. 2 shows a schematic block diagram of a system 50 for controlling a brushed DC motor 26, 28. As shown in FIG. 2, the brushed DC motor 26, 28 includes a set of brushes 30, 32 for transmitting DC current from a stationary terminal to a rotor winding. The set of brushes 30, 32 includes a first brush 30 configured to be connected to a power source for receiving a DC current. The set of brushes 30, 32 also includes a second brush 32 configured to be connected to a current sink, such as a ground terminal.

The system 50 includes a controller 60. The controller 60 may include any suitable controller, such as an electronic control unit or other suitable controller. The controller 60 may be configured to control, for example, the various functions of the steering system and/or various functions of a vehicle. The controller 60 may include a processor 62 and a memory 64. The processor 62 may include any suitable processor, such as those described herein. Additionally, or alternatively, the controller 60 may include any suitable number of processors, in addition to or other than the processor 62. The memory 64 may comprise a single disk or a plurality of disks (e.g., hard drives), and includes a storage management module that manages one or more partitions within the memory 64. In some embodiments, memory 64 may include flash memory, semiconductor (solid state) memory or the like. The memory 64 may include Random Access Memory (RAM), a Read-Only Memory (ROM), or a combination thereof. The memory 64 may include instructions that, when executed by the processor 62, cause the processor 62 to, at least, control various aspects of the vehicle. Additionally, or alternatively, the memory 64 may include instructions that, when executed by the processor 62, cause the processor 62 to perform functions associated with the systems and methods described herein.

The controller 60 may be operably connected to a voltage regulator 52. The voltage regulator 52 may be configured to apply a DC voltage v to the first brush 30 of the brushed DC motor 26, 28. The voltage regulator 52 may generate the DC voltage v based on a voltage command v_{cmd} from the controller 60.

In some embodiments, and as shown in FIG. 2, the system 50 may include a current sensor 54 configured to measure the DC current supplied to the brushed DC motor 26, 28 and to transmit a motor current signal iₘ to the controller 60, representing an actual motor current in a winding of the brushed DC motor 26, 28. Additionally or alternatively, and as also shown in FIG. 2, the system 50 may include a position sensor 56 and configured to measure a rotational position of the brushed DC motor 26, 28 and to transmit a motor position signal ωₘ to the controller 60.

In some embodiments, the controller 60 may perform the methods described herein. However, the methods described herein as performed by the controller 60 are not meant to be limiting, and any type of software executed on a controller or processor can perform the methods described herein without departing from the scope of this disclosure. For example, a controller, such as a processor executing software within a computing device, can perform the methods described herein.

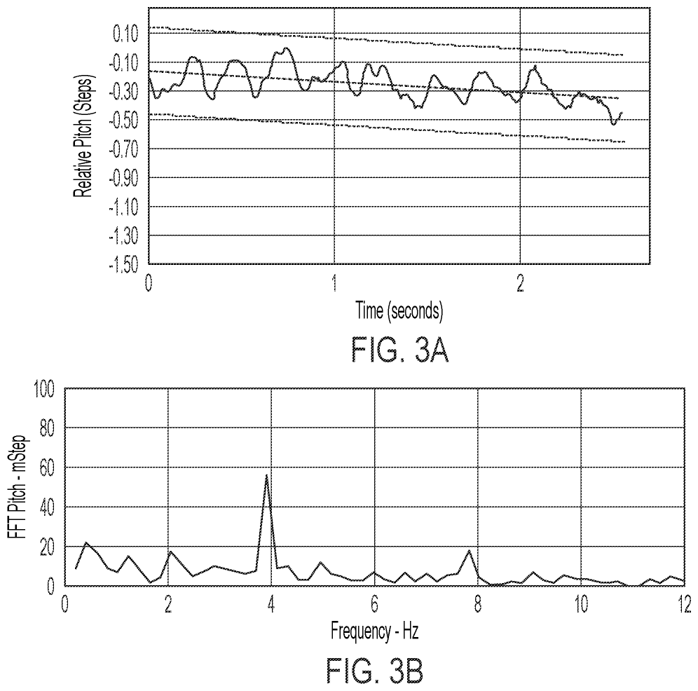

FIG. 3A shows a graph of relative pitch over time for the rake actuator motor 28 moving the CPM 20 in a column down direction. FIG. 3B shows a graph showing a fast Fourier transform (FFT) analysis of pitch vs. frequency for the CPM module moving in the column down direction. FIG. 3 shows a large spike at about 4 Hz. This spike represents undesirable noise or vibration that may be perceptible to a person using the CPM. Similar undesirable noise or vibration may be produced by the rake actuator motor 28 moving in either direction or by the telescoping actuator motor 26 moving in either direction. It is an object of the method and system of the present disclosure to minimize or eliminate such vibration that can otherwise cause undesired noise and vibration. Moreover, the techniques of the present disclosure may be applicable reducing noise or vibration in any brushed DC motor application.

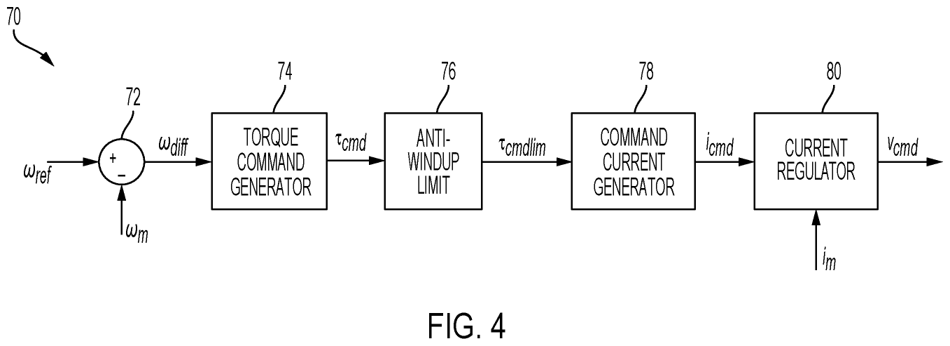

FIG. 4 shows a schematic block diagram of a motor controller 70 for operating a DC motor, according to aspects of the present disclosure. The motor controller 70 is configured as a speed controller that follows a speed-torque-voltage path. However, the principles of the present disclosure may be applied to other controller configurations.

The motor controller 70 includes a subtractor 72 configured to subtract the motor speed ωₘ from a speed command signal ω_{ref}, and to compute a speed difference signal ω_{diff} representing the difference between the speed command signal ω_{ref} and the motor speed ωₘ. The motor controller 70 also includes a torque command generator 74 that is configured to generate a torque command signal τ_{cmd} based on the speed difference signal ω_{diff}. The torque command generator 74 may use a proportional-integral (PI) control loop to generate the torque command signal τ_{cmd}, however, other control techniques may be used, such as a proportional-integral-derivative (PID) control loop, or a lookup table.

The motor controller 70 also includes a torque limiter 76, which may also be called an anti-windup limit, configured to generate a limited torque command τ_{cmdlim} based on the torque command signal τ_{cmd}. The torque limiter 76 may limit the torque command signal τ_{cmd} based one or more operating constraints, such as a supply current limit value Iₛₗᵢₘ, a motor current limit I_{MAX}, and/or a maximum available voltage value V_{MAX}.

The motor controller 70 also includes a command current generator 78 configured to generate a current command i_{cmd} based on the limited torque command τ_{cmdlim}. In some embodiments, the command current generator 78 generates the current command i_{cmd} by dividing the limited torque command τ_{cmdlim} by a back-EMF constant K.

The motor controller 70 also includes a current regulator 80 that is configured to generate a voltage command v_{cmd} based on the current command i_{cmd}. In some embodiments, and as shown in FIG. 4, the current regulator 80 takes, as an input, the motor current signal iₘ. The current regulator 80 may use a control loop, such as a PI control loop to compute the voltage command v_{cmd} based on a difference between the current command i_{cmd} and the motor current signal iₘ. Alternatively or additionally, the current regulator 80 may use a reference model, such as an equation or a lookup table to determine the voltage command v_{cmd} based on the current command i_{cmd} and the motor current signal iₘ.

Equations (1)-(2), below, show the mathematical model of a DC motor.

$$v = R i + L \frac{d i}{d t} + K ω + {v}_{b} \qquad ( 1 )$$

$$J \frac{d ω}{d t} = {τ}_{e} - {τ}_{L F} - B ω \qquad ( 2 )$$

Here, v is the voltage applied to the DC motor, i is the motor current, R is the resistance, L is the inductance, K is the back EMF constant, J is the inertia of the motor, B is the viscous constant, ω is the motor speed, τₑ is the generated electrical torque, and τ_{LF} is a load plus friction torque. v_{b} denotes the voltage drop due to the brushes 30, 32.

Equation (3), below, describes the brush voltage drop v_{b} due to the brushes 30, 32. V₀ is a brush voltage parameter of the motor and I₀ is a current parameter of the motor.

The brush voltage drop v_{b} occurs in the direction of the motor current i, as described in equation (3).

$${v}_{b} = sign ( i ) * {V}_{0} ( 1 - {e}^{- \vert \frac{i}{{I}_{0}} \vert} ) \qquad ( 3 )$$

where sign (i) represents the polarity of the current and is −1 for a negative motor current (i.e., where i<0), 0 for zero motor current (i.e. i=0), or +1 for a positive motor current (where i>0).

The generated electrical torque τₑ is directly related to the motor current as set forth in equation (4). τ_{LF} is the load and friction torque and can be expressed by (5).

$${τ}_{e} = K i \qquad ( 4 )$$

$${τ}_{LF} ( θ ) = {τ}_{L} ( θ ) + C * sign ( ω ) \qquad ( 5 )$$

Here, θ is a motor position, C is the Coulomb constant and τ_{L} denotes the load torque. For CPM applications, the load torque τ_{L} will heavily depend on the column position. Note that when the motor is connected with a larger system i.e. the steering system, the load torque, the load, and friction torques increase along with the resultant inertia.

Equation (6), below, provides a general approach to calculating a torque command τ_{cmd} from the actual speed ωₘ and the reference speed ω_{ref}, using a PI control loop.

$${τ}_{cmd} = {K}_{p} ( {ω}_{ref} - {ω}_{m} ) + {K}_{i} \int ( {ω}_{ref} - {ω}_{m} ) dt \qquad ( 6 )$$

where Kₚ represents a proportional gain value, and Kᵢ represents an integral gain value. Either or both of the proportional gain value Kₚ and/or the integral gain value Kᵢ may be constants.

The load-friction torque profiles based on the motor position θ can be added as the feedforward term in equation (7). A first technique of the present disclosure to calculate the torque command is shown in equation (7).

$${τ}_{cmd} = {K}_{p} ( {ω}_{ref} - {ω}_{m} ) + {K}_{i} \int ( {ω}_{ref} - {ω}_{m} ) dt + {τ}_{L F} ( θ ) \qquad ( 7 )$$

Equation (7) may be represented as a closed-loop transfer function, as shown in equation (8).

$$\frac{{ω}_{m}}{{ω}_{ref}} = \frac{{K}_{p} ( s + \frac{{K}_{i}}{{K}_{p}} )}{J ( {s}^{2} + \frac{B + {K}_{p}}{J} + \frac{{K}_{i}}{J} )} \qquad ( 8 )$$

To get a first-order response, one pole is placed at the zero location, as shown in equation (9).

$$\frac{{ω}_{m}}{{ω}_{ref}} = \frac{a}{s + a} \qquad ( 9 )$$

Here, −a is the desired pole location first-order equation. a is also referred to as the bandwidth of the system. The bandwidth a corresponds to a reciprocal of a time constant (in seconds) for a step response to reach 1-1/e≈63.2% of its final (asymptotic) value (e.g. from a step increase). The bandwidth a may be determined based on the requirement for a particular application of the brushed DC motor. Assuming the pole to be canceled out by a zero of the same value, is located at −a₁. The following equation set (10) can be derived from equation (8).

$$a + {a}_{1} = \frac{b + {K}_{p}}{J} \qquad ( 10 )$$

$${aa}_{1} = \frac{{K}_{i}}{J}$$

$${a}_{1} = \frac{{K}_{i}}{{K}_{p}}$$

Solving these equations, we get the proportional gain Kₚ and the integral gain Kᵢ as set forth in equation set (11).

$${K}_{p} = aJ and {K}_{i} = aB \qquad ( 11 )$$

One drawback with the first two controllers is that the zero and pole are canceled at −B/J, and this value depends on the system parameters, with no way to control it. At a certain speed, the system may exhibit undesirable performance. Also, some other constraints of the gains may appear during operation. For example, the integral gain Kᵢ can be limited to a number for stable operation. This may lead to the pole location being set at a particular location, as shown in equation set (11).

Equation (7) can be modified with a feedforward gain term, K_{f}, as shown in equation (12), below. This provides an additional degree of freedom to maintain one of the gains within a certain limit and at the same time set the poles and zero.

$${τ}_{c m d} = {K}_{p} ( {K}_{f} {ω}_{ref} - {ω}_{m} ) + {K}_{i} \int ( {ω}_{ref} - {ω}_{m} ) dt + {τ}_{L F} ( θ ) \qquad ( 12 )$$

Friction and load torque can be ignored for a small and smooth system. The closed-loop transfer function may be represented as shown in equation (13):

$$\frac{{ω}_{m}}{{ω}_{ref}} = \frac{{K}_{p} {K}_{f} ( s + \frac{{K}_{i}}{{K}_{p} {K}_{f}} )}{J ( {s}^{2} + \frac{B + {K}_{p}}{J} + \frac{{K}_{i}}{J} )} \qquad ( 13 )$$

Setting the three controller gains K_{f}, Kₚ, and Kᵢ as set forth in equation set (14), reduces equation (13) to a first-order system as set forth in equation (15). The two poles and zero are set at the same location in this case.

$${K}_{f} = \frac{{K}_{i}}{a {K}_{p}} ; {K}_{p} = 2 aJ ; and {K}_{i} = {a}^{2} J \qquad ( 14 )$$

$$\frac{{ω}_{m}}{{ω}_{ref}} = \frac{a}{s + a} \qquad ( 15 )$$

It may be found that the system becomes unstable over a certain value for the integral gain Kᵢ=Kᵢₗᵢₘ. If the traditional controller of equation (6) is used with gain values as shown in equation set (11), there may be no option to set up the pole over aₗᵢₘ=KᵢₗᵢₘB. However, using the controller of equation (12) with the feedforward gain term, K_{f}, Provides for setting the gains as described below by putting one pole and a zero to −a₁ and other pole or closed loop pole at −a. Equation set (16), below, shows the governing equations to set the gains to limit the integral gain Kᵢ and at the same time, select the desired pole location.

$$a + {a}_{1} = \frac{b + {K}_{p}}{J} \qquad ( 16 )$$

$${aa}_{1} = \frac{{K}_{i lim}}{J}$$

$${a}_{1} = \frac{{K}_{i lim}}{{K}_{p} {K}_{f}}$$

Solving these equations, values can be derived as set forth in equation set (17). Here, Kᵢ=Kᵢₗᵢₘ and a is set to a desired location.

$${a}_{1} = \frac{{K}_{i lim}}{J a} ; {K}_{p} = \frac{{K}_{i lim}}{a} + J a - B ; and {K}_{f} = \frac{J a}{{K}_{i lim} + Ja - B} \qquad ( 17 )$$

From the torque command computed using the controller of equation (7) or equation (12), the current command is calculated as set forth in equation (18).

$${i}_{cmd} = \frac{{τ}_{cmd}}{K} \qquad ( 18 )$$

The voltage command is measured using the system model for voltage mode operation. In equation (19), the actual motor current i is used for the dynamic term,

$$L \frac{di}{dt}$$

to avoid adding a huge voltage due to the sudden change of the command torque τ_{cmd} and command current i_{cmd}.

$${v}_{cmd} = R {i}_{cmd} + L \frac{d i}{d t} + K {ω}_{m} + sign ( i ) * {V}_{0} ( 1 - {e}^{- \vert \frac{i}{{I}_{0}} \vert} ) \qquad ( 19 )$$

For current mode operation, the existing architecture for the brush DC motor for the EPS system is used, and as set forth in equation (20). The gains of the PI current regulator are set as shown in equation set (21).

$${v}_{cmd} = {K}_{pc} ( {i}_{cmd} - i ) + {K}_{ic} \int ( {i}_{cmd} - i ) dt \qquad ( 20 )$$

$${K}_{pc} = {ω}_{d} L ; and {K}_{ic} = {ω}_{d} R \qquad ( 21 )$$

The controller performance is observed and compared with the traditional approach for position-dependent load torque. The desired pole location −a, may have a value of −20, and the current regulator pole ω_{d} may have a value of −200π. The current regulator pole ω_{d} may be set at a higher value than the command current generator since the inner loop gain may need to be set to at least 10 times higher than the outer loop to avoid undesired interference. A position-dependent load profile is applied on the motor with constant and sinusoidal terms.

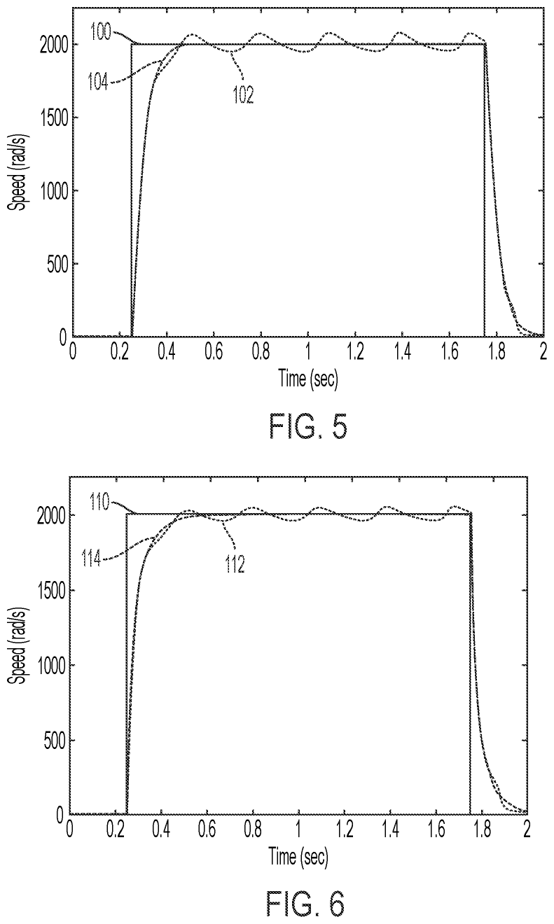

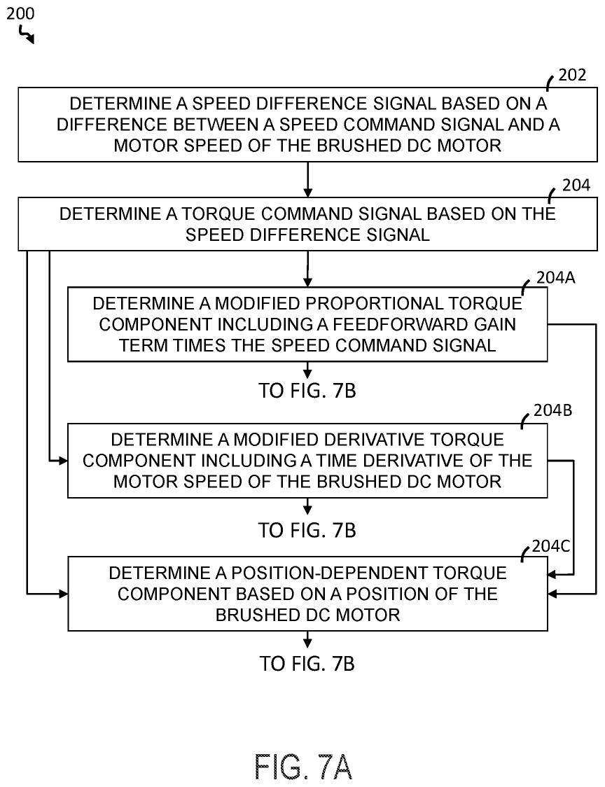

FIGS. 5-6 show a comparison of performances between the proposed method of equation (7) with load-friction torque adjustment terms and gains of equation set (11), and the traditional method of equation (6) with the gain of equation set (11) with voltage and current modes respectively.

FIG. 5 shows a graph of motor speed vs. time and includes a first plot 100 showing a speed reference with a step function that jumps from 0 to 2000 radians per second at time t=0.25 s, and then back from 2000 to 0 radians per second at time t=1.75 s. The graph of FIG. 5 also includes a second plot 102 showing motor speed using a traditional control technique of equation (6) with gains of equation set (11) for voltage control. The graph of FIG. 5 also includes a third plot 104 showing motor speed using a control technique of the present disclosure, as set forth in equation (7) with gains of equation set (11) for voltage control. As shown, the control technique of the present disclosure, as shown on the third plot 104 is generally closer to the speed reference of the first plot 100 and does not exhibit the oscillation present in the traditional control technique shown on the second plot 102.

FIG. 6 shows a graph of motor speed vs. time and includes a fourth plot 110 showing a speed reference with a step function that jumps from 0 to 2000 radians per second at time t=0.25 s, and then back from 2000 to 0 radians per second at time t=1.75 s. The graph of FIG. 6 also includes a fifth plot 112 showing motor speed using a traditional control technique of equation (6) with gains of equation set (11) for current control. The graph of FIG. 6 also includes a sixth plot 114 showing motor speed using a control technique of the present disclosure, as set forth in equation (7) with gains of equation set (11) for current control. As shown, the control technique of the present disclosure, as shown on the sixth plot 114 is generally closer to the speed reference of the fourth plot 110 and does not exhibit the oscillation present in the traditional control technique shown on the fifth plot 112.

The first proposed controller with the traditional PI controller and load-torque adjustment provides significantly better speed response in steady-state in both voltage and current modes. The time constants from the step response match with the time constant of 0.05s set by the pole −a (located at −20) of the speed-to-torque PI controller. The extra value around 0.0026 s is caused by the delays of sampling of different components running at 500 Hz and 16 kHz sampling rates and the time constant of the current regulator for current mode operation. The proposed modified PI controller with as set forth in equation (12) and with gains of equation set (14) also provides similar performance and results with position-varying load.

Another possible approach that can reduce the speed ripples without any adjustment is to introduce a differentiation term to the PI controller of equation (6). Equation (22), below, shows the proposed modified Proportional, Integral, Derivative (PID) controller. The proposed modified PID controller differs from a conventional PID controller in that

$${K}_{d} \frac{d {ω}_{m}}{dt}$$

the derivative term, is based on a time derivative of only the motor speed ωₘ, instead of a difference term, such as (ω_{ref}−ωₘ), as in a conventional PID controller.

$${τ}_{cmd} = {K}_{p} ( {ω}_{ref} - {ω}_{m} ) + {K}_{i} \int ( {ω}_{ref} - {ω}_{m} ) dt - {K}_{d} \frac{d {ω}_{m}}{dt} \qquad ( 22 )$$

The modified PID controller of equation (22) may be represented as a closed-loop transfer function, as shown in equation (23).

$$\frac{{ω}_{m}}{{ω}_{ref}} = \frac{s {K}_{p} + {K}_{i}}{{s}^{2} ( J + {K}_{d} ) + s ( B + {K}_{p} ) + {K}_{i}} \qquad ( 23 )$$

The transfer function can be reduced to a first-order system with the pole at −a, by setting the gains as shown in equation set (24).

$${K}_{d} = \frac{B}{a} ; {K}_{p} = B ; and {K}_{i} = a B \qquad ( 24 )$$

The closed-loop transfer function becomes, as shown in equation (25):

$$\frac{{ω}_{m}}{{ω}_{ref}} = \frac{a}{s + a} \qquad ( 25 )$$

Equation (22) can be adjusted to accommodate the load change, as shown in equation (26):

$${τ}_{cmd} = {K}_{p} ( {ω}_{ref} - {ω}_{m} ) + {K}_{i} \int ( {ω}_{ref} - {ω}_{m} ) dt - {K}_{d} \frac{d {ω}_{m}}{dt} + {τ}_{LF} ( θ ) \qquad ( 26 )$$

For all the methods of the present disclosure, increasing the pole locations decreases the speed ripple. However, since there will be some delay with filtering and processing, it may be advantageous to set the pole at least 20 times lower than the sampling frequency. The pole location may be further calibrated, for example, by experimentation. In conditions with no load or constant load, all the control techniques of the present disclosure work well without adjustment. The adjustment terms may be advantageous in applications where the load varies significantly with position.

In case of a current measurement fault, the current regulator may not use the current control mode. The voltage mode equation can be modified, as shown in equation (27) in case of a current measurement fault. All the speed-to-torque controllers may be capable of compensate for the missing terms due to no current data in voltage mode. Alternatively, the voltage command can be determined as set forth in equation (28).

$${v}_{cmd} = R {i}_{cmd} + K {ω}_{m} \qquad ( 27 )$$

$${v}_{cmd} = R {i}_{dmd} + L \frac{d {i}_{cmd}}{dt} + K {ω}_{m} + sign ( {i}_{c m d} ) * {V}_{0} ( 1 - {e}^{- \vert \frac{{i}_{cmd}}{{I}_{0}} \vert} ) \qquad ( 28 )$$

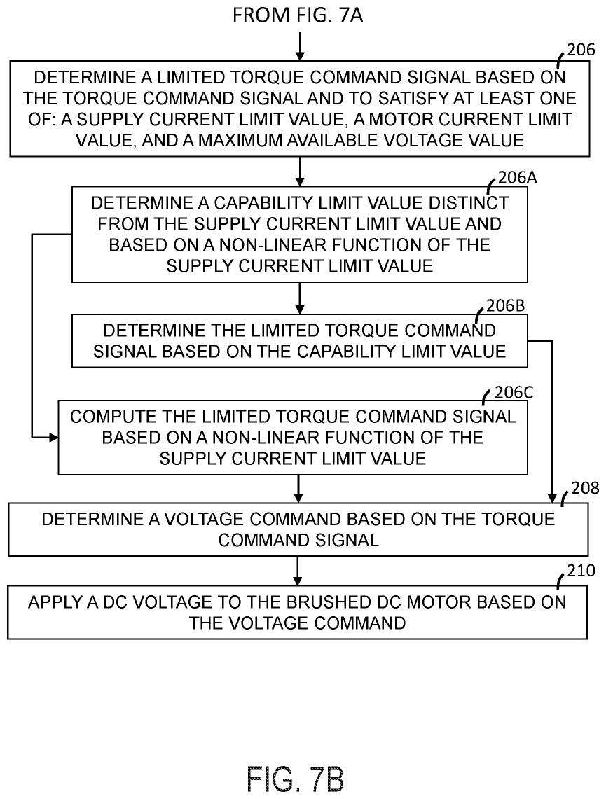

FIGS. 7A-7B show a flow diagram listing steps in a method 200 for operating a DC motor, according to aspects of the present disclosure. The method 200 can be performed by the motor controller 70 of the present disclosure. As can be appreciated in light of the disclosure, the order of operation within the method is not limited to the sequential execution as illustrated in FIGS. 7A-7B, but may be performed in one or more varying orders as applicable and in accordance with the present disclosure.

At 202, the method 200 determines a speed difference signal based on a difference between a speed command signal and a motor speed of the brushed DC motor. For example, the processor 62 may execute instructions to implement the subtractor 72 to compute the speed difference signal ω_{diff} representing the difference between the speed command signal ω_{ref} and the motor speed ωₘ.

At 204, the method 200 determines a torque command signal based on the speed difference signal. For example, the processor 62 may execute instructions to implement the torque command generator 74 to generate the torque command signal τ_{cmd} based on the speed difference signal ω_{diff}. The torque command signal τ_{cmd} may include one or more of a modified proportional torque component and/or a modified derivative torque component.

Step 204 may include determining, at 204A, a modified proportional torque component including a feedforward gain term times the speed command signal. For example, the torque command signal τ_{cmd} may include the modified proportional torque component Kₚ (K_{f}ω_{ref}−ωₘ), as described in equation (12).

In some embodiments, the method 200 further includes determining the feedforward gain term to cause the brushed DC motor satisfy a given bandwidth. For example, the feedforward gain term may be determined as set forth in equation set (14).

Step 204 may include determining, at 204B, a modified derivative torque component including a time derivative of the motor speed of the brushed DC motor. For example, the torque command signal τ_{cmd} may include the modified derivative torque component

$${K}_{d} \frac{d {ω}_{m}}{dt} ,$$

as described in equation (22).

Step 204 may further include determining, at 204C, a position-dependent torque component of the torque command signal based on a position of the brushed DC motor and/or a direction of the brushed DC motor. For example, the processor 62 may execute instructions to compute or otherwise determine the position-dependent torque component, τ_{LF}(θ), based on the motor position θ, and the torque command signal τ_{cmd} may include position-dependent torque component, τ_{LF}(θ), as described in equation (26). The direction may include the brushed DC motor operating in a forward direction or in a reverse direction opposite the forward direction, and the position-dependent torque component may be different for the brushed the brushed DC motor operating forward, reverse, or at a standstill condition.

In some embodiments, the position-dependent torque component is further based on an operating direction of the brushed DC motor. For example, the position-dependent torque component may be different for the brushed DC motor operating in forward or reverse directions. Such forward or reverse directions may correspond to the telescoping actuator motor 26 moving the CPM 20 in a corresponding inward or outward direction or the rake actuator motor 28 moving the CPM 20 in a corresponding column-up or column-down direction.

In some embodiments, the position-dependent torque component may be determined using a lookup table based on the position of the brushed DC motor.

At 206, the method 200 determines a limited torque command signal based on the torque command signal and to satisfy at least one of: a supply current limit value, a motor current limit value, and a maximum available voltage value. For example, the processor 62 may execute instructions to implement the torque limiter 76 to determine the limited torque command τ_{cmdlim} based on the torque command signal τ_{cmd}.

Step 206 may include determining, at 206A, a capability limit value distinct from the supply current limit value and based on a non-linear function of the supply current limit value; and determining, at 206B, the limited torque command signal based on the capability limit value. For example, the torque limiter 76 may function to determine the limited torque command τ_{cmdlim} based on a capability limit, which may be determined as described in U.S. Pat. No. 10,530,282 to Pramod et al. and assigned to Steering Solutions IP Holding Corporation.

Step 206 may include computing, at 206C, the limited torque command signal based on a non-linear function of the supply current limit value. For example, the torque limiter 76 may function to determine the limited torque command τ_{cmdlim} based on non-linear function of the supply current limit value, which may be determined as described in U.S. Pat. No. 11,290,042 to Pramod et al. and assigned to Steering Solutions IP Holding Corporation.

At 208, the method 200 determines a voltage command based on the torque command signal. For example, the processor 62 may execute instructions to implement the command current generator 78 and the current regulator 80, with the command current generator 78 generating a current command i_{cmd} based on the limited torque command τ_{cmdlim}, and with the current regulator 80 generating the voltage command v_{cmd} based on the current command i_{cmd}.

At 210, the method 200 applies a DC voltage to the brushed DC motor based on the voltage command. For example, the voltage regulator 52 may generate and apply the DC voltage v to the first brush 30 of the brushed DC motor 26, 28, with the DC voltage v based on the voltage command v_{cmd} from the controller 60.

The present disclosure provides a method of controlling a brushed direct current (DC) motor. The method includes: determining a speed difference signal based on a difference between a speed command signal and a motor speed of the brushed DC motor; determining a torque command signal based on the speed difference signal; determining a voltage command based on the torque command signal; and applying a DC voltage to the brushed DC motor based on the voltage command. Determining the torque command signal based on the speed difference signal further includes at least one of: determining a modified proportional torque component including a feedforward gain term times the speed command signal, and wherein the torque command signal includes the modified proportional torque component; and determining a modified derivative torque component including a time derivative of the motor speed of the brushed DC motor, and wherein the torque command signal includes the modified derivative torque component.

In some embodiments, determining the torque command signal based on the speed difference signal includes determining the modified proportional torque component including the feedforward gain term times the speed command signal, and wherein the torque command signal includes the modified proportional torque component.

In some embodiments, the method further includes determining the feedforward gain term to cause the brushed DC motor satisfy a given bandwidth.

In some embodiments, the feedforward gain term is determined in accordance with: K_{f}=Kᵢ/aKₚ, where K_{f} is the feedforward gain term, Kᵢ is an integral gain term, Kₚ is a proportional gain term, and a is the given bandwidth.

In some embodiments, determining the torque command signal based on the speed difference signal includes determining the modified derivative torque component including the time derivative of the motor speed of the brushed DC motor, and wherein the torque command signal includes the modified derivative torque component.

In some embodiments, the method further includes determining a position-dependent torque component based on a position of the brushed DC motor. In some embodiments, the torque command signal includes the position-dependent torque component.

In some embodiments, the position-dependent torque component is further based on an operating direction of the brushed DC motor.

In some embodiments, determining the position-dependent torque component includes using a lookup table to determine position-dependent torque component based on the position of the brushed DC motor.

In some embodiments, the method further includes determining a limited torque command signal based on the torque command signal and to satisfy at least one of: a supply current limit value, a motor current limit value, and a maximum available voltage value. In some embodiments, determining the voltage command further includes determining the voltage command based on the limited torque command signal.

In some embodiments, determining the limited torque command signal based on the torque command signal further includes at least one of: determining a capability limit value distinct from the supply current limit value and based on a non-linear function of the supply current limit value, and determining the limited torque command signal based on the capability limit value; and/or computing the limited torque command signal based on a non-linear function of the supply current limit value.

The present disclosure provides a motor control system. The motor control system includes: a brushed direct current (DC) motor having a set of brushes; a voltage regulator configured to apply a DC voltage to the brushed DC motor based on a voltage command; and a controller. The controller is configured to: determine a speed difference signal based on a difference between a speed command signal and a motor speed of the brushed DC motor; determine a torque command signal based on the speed difference signal; and determine the voltage command based on the torque command signal. Determining the torque command signal based on the speed difference signal includes at least one of: determining a modified proportional torque component including a feedforward gain term times the speed command signal, and wherein the torque command signal includes the modified proportional torque component; and determining a modified derivative torque component including a time derivative of the motor speed of the brushed DC motor, and wherein the torque command signal includes the modified derivative torque component.

In some embodiments, determining the torque command signal based on the speed difference signal further includes determining the modified proportional torque component including the feedforward gain term times the speed command signal, and wherein the torque command signal includes the modified proportional torque component.

In some embodiments, the controller is further configured to determine the feedforward gain term to cause the brushed DC motor satisfy a given bandwidth.

In some embodiments, the controller is further configured to determine the feedforward gain term in accordance with:

$${K}_{f} = \frac{{K}_{i}}{a {K}_{p}} ,$$

where K_{f} is the feedforward gain term, Kᵢ is an integral gain term, Kₚ is a proportional gain term, and a is the given bandwidth.

In some embodiments, determining the torque command signal based on the speed difference signal includes determining the modified derivative torque component including the time derivative of the motor speed of the brushed DC motor, and wherein the torque command signal includes the modified derivative torque component.

In some embodiments, the controller is further configured to determine a position-dependent torque component based on a position of the brushed DC motor, and the torque command signal includes the position-dependent torque component.

In some embodiments, the position-dependent torque component is further based on an operating direction of the brushed DC motor.

In some embodiments, determining the position-dependent torque component includes using a lookup table to determine position-dependent torque component based on the position of the brushed DC motor.

In some embodiments, the controller is further configured to determine a limited torque command signal based on the torque command signal and to satisfy at least one of: a supply current limit value, a motor current limit value, and a maximum available voltage value, and determining the voltage command further includes determining the voltage command based on the limited torque command signal.

The present disclosure also provides a method of operating a brushed direct current (DC) motor for adjusting a column position of a steering system in a vehicle. The method includes: determining a speed difference signal based on a difference between a speed command signal and a motor speed of the brushed DC motor; determining a torque command signal based on the speed difference signal; determining a voltage command based on the torque command signal; and applying a DC voltage to the brushed DC motor based on the voltage command. In some embodiments, determining the torque command signal based on the speed difference signal further includes at least one of: determining a modified proportional torque component including a feedforward gain term times the speed command signal, with the torque command signal including the modified proportional torque component; determining a modified derivative torque component including a time derivative of the motor speed of the brushed DC motor, with the torque command signal including the modified derivative torque component; and determining a position-dependent torque component based on a position of the brushed DC motor, with the torque command signal including the position-dependent torque component.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in scope with the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

What is claimed is:

1. A method of controlling a brushed direct current (DC) motor, comprising:
determining a speed difference signal based on a difference between a speed command signal and a motor speed of the brushed DC motor;
determining a torque command signal based on the speed difference signal;
determining a voltage command based on the torque command signal; and
applying a DC voltage to the brushed DC motor based on the voltage command,
wherein determining the torque command signal based on the speed difference signal further includes at least one of:
determining a modified proportional torque component including a feedforward gain term times the speed command signal, and wherein the torque command signal includes the modified proportional torque component; and
determining a modified derivative torque component including a time derivative of the motor speed of the brushed DC motor, and wherein the torque command signal includes the modified derivative torque component.

2. The method of claim 1, wherein determining the torque command signal based on the speed difference signal includes determining the modified proportional torque component including the feedforward gain term times the speed command signal, and wherein the torque command signal includes the modified proportional torque component.

3. The method of claim 2, further including determining the feedforward gain term to cause the brushed DC motor satisfy a given bandwidth.
$${K}_{f} = \frac{{K}_{i}}{a {K}_{p}} {K}_{f} {K}_{i} {K}_{p} a 4.$$
The method of claim 3, wherein the feedforward gain term is determined in accordance with: where is the feedforward gain term, is an integral gain term, is a proportional gain term, and is the given bandwidth.
$${K}_{f} = \frac{{K}_{i}}{a {K}_{p}} {K}_{f} {K}_{i} {K}_{p} a$$

5. The method of claim 1, wherein determining the torque command signal based on the speed difference signal includes determining the modified derivative torque component including the time derivative of the motor speed of the brushed DC motor, and wherein the torque command signal includes the modified derivative torque component.

6. The method of claim 1, further including determining a position-dependent torque component based on a position of the brushed DC motor, and
wherein the torque command signal includes the position-dependent torque component.

7. The method of claim 6, wherein the position-dependent torque component is further based on an operating direction of the brushed DC motor.

8. The method of claim 6, wherein determining the position-dependent torque component includes using a lookup table to determine position-dependent torque component based on the position of the brushed DC motor.

9. The method of claim 1, further including: determining a limited torque command signal based on the torque command signal and to satisfy at least one of: a supply current limit value, a motor current limit value, and a maximum available voltage value, and
wherein determining the voltage command further includes determining the voltage command based on the limited torque command signal.

10. The method of claim 9, wherein determining the limited torque command signal based on the torque command signal further includes at least one of:
determining a capability limit value distinct from the supply current limit value and based on a non-linear function of the supply current limit value, and determining the limited torque command signal based on the capability limit value; and
computing the limited torque command signal based on a non-linear function of the supply current limit value.

11. A motor control system, comprising:
a brushed direct current (DC) motor having a set of brushes;
a voltage regulator configured to apply a DC voltage to the brushed DC motor based on a voltage command; and
a controller configured to:
determine a speed difference signal based on a difference between a speed command signal and a motor speed of the brushed DC motor;
determine a torque command signal based on the speed difference signal; and
determine the voltage command based on the torque command signal,
wherein determining the torque command signal based on the speed difference signal includes at least one of:
determining a modified proportional torque component including a feedforward gain term times the speed command signal, and wherein the torque command signal includes the modified proportional torque component; and
determining a modified derivative torque component including a time derivative of the motor speed of the brushed DC motor, and wherein the torque command signal includes the modified derivative torque component.

12. The motor control system of claim 11, wherein determining the torque command signal based on the speed difference signal further includes determining the modified proportional torque component including the feedforward gain term times the speed command signal, and wherein the torque command signal includes the modified proportional torque component.

13. The motor control system of claim 12, wherein the controller is further configured to determine the feedforward gain term to cause the brushed DC motor satisfy a given bandwidth.
$${K}_{f} = \frac{{K}_{i}}{a {K}_{p}} {K}_{f} {K}_{i} {K}_{p} a 14.$$
The motor control system of claim 13, wherein the controller is further configured to determine the feedforward gain term in accordance with: where is the feedforward gain term, is an integral gain term, is a proportional gain term, and is the given bandwidth.
$${K}_{f} = \frac{{K}_{i}}{a {K}_{p}} {K}_{f} {K}_{i} {K}_{p} a$$

15. The motor control system of claim 11, wherein determining the torque command signal based on the speed difference signal includes determining the modified derivative torque component including the time derivative of the motor speed of the brushed DC motor, and wherein the torque command signal includes the modified derivative torque component.

16. The motor control system of claim 11, wherein the controller is further configured to determine a position-dependent torque component based on a position of the brushed DC motor, and
wherein the torque command signal includes the position-dependent torque component.

17. The motor control system of claim 16, wherein the position-dependent torque component is further based on an operating direction of the brushed DC motor.

18. The motor control system of claim 16, wherein determining the position-dependent torque component includes using a lookup table to determine position-dependent torque component based on the position of the brushed DC motor.

19. The motor control system of claim 11, wherein the controller is further configured to determine a limited torque command signal based on the torque command signal and to satisfy at least one of: a supply current limit value, a motor current limit value, and a maximum available voltage value, and
wherein determining the voltage command further includes determining the voltage command based on the limited torque command signal.

20. A method of operating a brushed direct current (DC) motor for adjusting a column position of a steering system in a vehicle, comprising:
determining a speed difference signal based on a difference between a speed command signal and a motor speed of the brushed DC motor;
determining a torque command signal based on the speed difference signal;
determining a voltage command based on the torque command signal; and
applying a DC voltage to the brushed DC motor based on the voltage command,
wherein determining the torque command signal based on the speed difference signal further includes at least one of:
determining a modified proportional torque component including a feedforward gain term times the speed command signal, and wherein the torque command signal includes the modified proportional torque component;
determining a modified derivative torque component including a time derivative of the motor speed of the brushed DC motor, and wherein the torque command signal includes the modified derivative torque component; and
determining a position-dependent torque component based on a position of the brushed DC motor, and wherein the torque command signal includes the position-dependent torque component.
